(19) United States
(12) Patent Application Publication
(10) Pub. No.: US 2014/0184917 A1
(43) Pub. Date: Jul. 3, 2014

(54) AUTOMATED CHANNEL SWITCHING

(71) Applicant: SLING MEDIA PVT LTD, Bangalore (IN)

(72) Inventor: Yatish Jayant NaikRaikar, Bangalore (IN)

(73) Assignee: SLING MEDIA PVT LTD, Bangalore (IN)

(21) Appl. No.: 13/788,644

(22) Filed: Mar. 7, 2013

(30) Foreign Application Priority Data
Dec. 31, 2012 (IN) 5547/CHE/2012

(51) Int. Cl. H04N 5/14

(52) U.S. Cl. CPC H04N 5/147
USPC 348/700

(57) ABSTRACT

Systems, devices and methods are described to automatically detect scene changes in television programming streams received by a set top box or other television receiver, to classify the detected scenes, and to automatically provide the classified scenes to a viewer if the scenes are determined to be of interest to the viewer.

### PRIORITY CLAIM

This application claims priority to India Provisional Patent Application Serial No. 5547/CHE/2012 filed on Dec. 31, 2012, which is incorporated herein by reference.

### TECHNICAL FIELD

The following discussion generally relates to systems and techniques for automatically detecting scene changes in television programming. The following discussion also describes systems, devices and techniques for automatically changing channels in a television receiver based upon detected changes in program scenes.

### BACKGROUND

Watching television continues to be a primary source of entertainment for people throughout the world. Typically, viewers receive television programming from any number of program sources such as cable programming, direct broadcast satellite (DBS), terrestrial broadcasts, streaming media, stored media (e.g., DVDs, Blue-Ray disks and/or the like), and any number of other sources.

With the large amount and variety of content that is now available, many consumers like to simultaneously view multiple programs. A viewer may opt to simultaneously watch both a sporting event and a movie, for example, hoping to enjoy the best portions of each broadcast while missing the less interesting portions, such as commercials or the like. Presently, it is very difficult for the viewer to know when the important scenes are coming up, especially in a live broadcast, so the viewer typically alternates back and forth between the programs being viewed, hoping to catch the “best” portions of both of them. This is inherently an imprecise process that can result in extra effort by the viewer, and that can often result in the viewer missing desired portions of one program or another.

Various attempts have been made to automate the channel switching process. Many have attempted, for example, to add metadata into the television program broadcast that allows the receiver to identify programming that can be automatically skipped, or automatically tuned. With the wealth of programming that is currently available from many different sources, however, it can be a substantial challenge to add the requisite metadata into all of the programming that is of interest to the viewer.

It is therefore desirable to provide systems, devices and/or processes that are able to automatically detect program scene changes in television programming and/or to automatically change channels based upon detected changes. These and other desirable features and characteristics will become apparent from the subsequent detailed description and the appended claims, taken in conjunction with the accompanying drawings and this background section.

### BRIEF SUMMARY

According to various exemplary embodiments, systems, devices and methods are described to automatically detect scene changes in television programming. Further embodiments may also automatically classify the newly-received scene and determine if the new scene is of interest to the viewer. If so, then the television receiver may be controlled to render the scene to the viewer.

Various exemplary embodiments provide methods executable by a media device that provides video programming comprising a first program and a second program for a viewer. The method suitably comprises initially providing the first program as an output for presentation to the viewer, receiving sequential frames of the second program at the media device during presentation of the first program, identifying changes between a current video frame of the second program and a prior video frame of the second program by the media device, automatically identifying a different scene of the second program by the media device if the changes between the current frame and the prior video frame exceed a threshold value, and, in response to identifying the different scene of the second program, the media device automatically switching to output the second program for presentation of the different scene to the viewer.

Other exemplary embodiments provide methods executable by a television receiver. The method suitably comprises receiving broadcast television program data representing a television program at the television receiver, wherein the broadcast television program data comprises a plurality of video frames and audio content associated with the television program, automatically detecting a change in a scene of the television program by the television receiver based upon changes in the video frames of the television program, automatically classifying the scene of the television program by the television receiver based upon the audio content associated with the television program, determining if the classified scene of the television program is of interest to a viewer of the television receiver, and, if the classified scene is of interest to the viewer of the television receiver, automatically providing the classified scene as an output for presentation to the viewer.

Still other embodiments provide a television receiver that comprises a receiver interface configured to receive broadcast television signals representing a television program, a display interface configured to provide the television program as an output for presentation to a viewer, a television tuner configured to decode the received broadcast television signals into video frames and audio data, and a processor configured to automatically detect changes in a scene depicted within the television program based upon changes in the video frames, to automatically classify the scene depicted within the television program based upon the audio data, to determine if the classified scene is of interest to the viewer, and, if the classified scene is of interest to the viewer, to control the display interface and thereby provide the classified scene as the output for presentation to the viewer.

Additional embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary television receiver system;

FIG. 2 is a flowchart of an exemplary process for automatically detecting scene changes in received television programming;

FIG. 3 is a flowchart of an exemplary process for automatically classifying scenes in received television programming; and

FIG. 4 is a flowchart of an exemplary process for processing recording timer data.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various embodiments, a television receiver, set top box (STB), personal video recorder (PVR) or other device 102 automatically detects scene changes in television programming 125 based upon changes in the video frames of the content 113 itself. Scenes may be classified based upon the audio content of the scene, and the classified scene can be automatically presented to the viewer if it is determined to be of interest to the viewer.

By automatically detecting scene changes and classifying the detected scenes at the receiver itself and based upon the content of the program itself, a very flexible system 100 can be created that allows for automatic scene selection/channel changing even though the content has not been especially enhanced or augmented for such purposes. Automatic detection based upon the content itself also allows the system to be used with content from various sources, including broadcast content, content stored on a DVR or other recording device, content obtained through streaming media, content obtained from a DVD or other media player, and/or the like.

To provide an example of the sort of flexibility that could be achieved in one embodiment, a particular viewer may wish to simultaneously watch a movie broadcast on a premium channel while also watching a football game. Such a viewer may select the football game for primary viewing, but may want to switch away from the game when action sequences or other more interesting scenes occur. The television receiver or other device 102 that is providing the content 125 for display to the viewer appropriately selects between tuners or other programming sources 112A-B in response to the viewer's preferences.

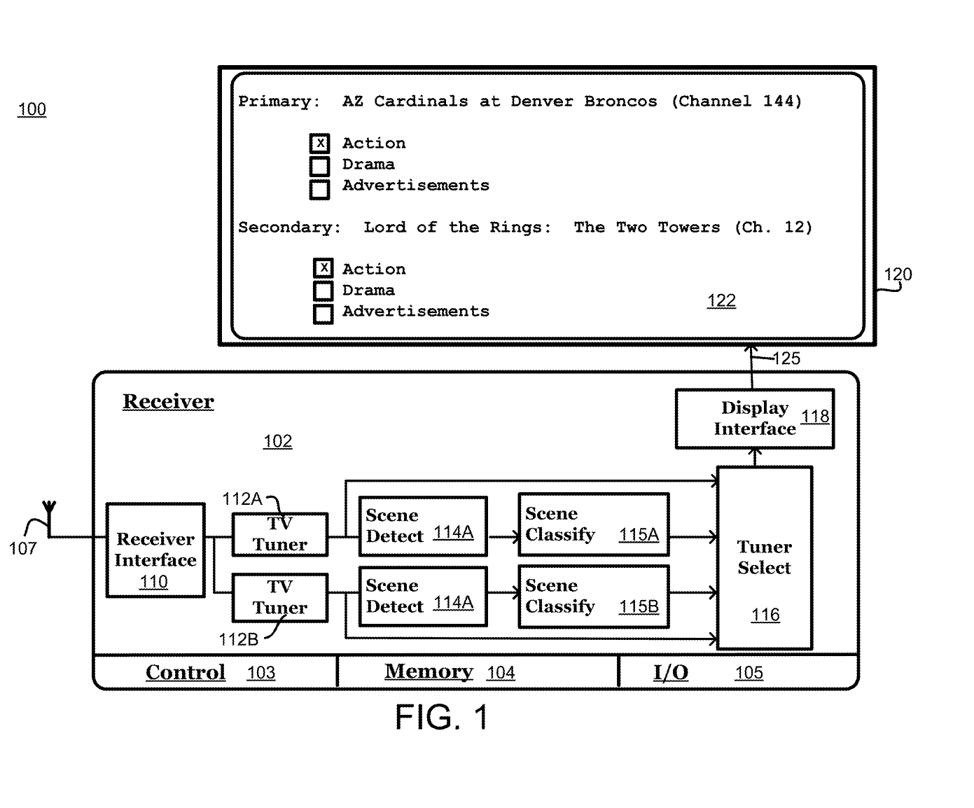

The example shown in FIG. 1, for example, shows an exemplary interface 122 that could be presented on a television or other display 120. This example shows an interface that allows the user to select one or more programs for simultaneous viewing, and that allows the user to select portions of each program that he or she wishes to watch. In this case, the viewer may wish to watch “action” sequences of both the primary and secondary programs while skipping over “drama” scenes and advertisements, when possible to do so. That is, the viewer is establishing a preference for action scenes over dramatic scenes in both programs. In this example, the receiver could automatically provide action scenes from the secondary program whenever dramatic scenes or advertisements were playing in the primary program. Conflicts between primary and secondary programs (e.g., when both programs are simultaneously showing “action” scenes in this example) can be resolved in any manner. Some implementations may simply give preference to the primary program over the secondary program; other implementations may further evaluate the scenes to determine if one or the other is more preferential to the viewer in any manner.

Television receiver 102 is any device that is capable of providing media content 125 for presentation to the viewer. In various embodiments, television receiver 102 is a conventional set top box, cable box, DBS receiver or the like that receives broadcast television signals via an antenna 107 or the like at a receiver interface 110. Other embodiments could implement equivalent functions and features in media player devices, digital video recorders (DVRs), and/or other devices as desired that may not necessarily receive broadcast television signals.

In the example illustrated in FIG. 1, receiver 102 includes multiple television tuners 112A-B that are each capable of decoding a television signal from an appropriate source and providing an output 113A-B representing the audio and video content of the decoded signal. Although FIG. 1 shows both tuners 112A-B as receiving signals from the receiver interface 110, equivalent embodiments could produce one or more monitored streams 113A-B from a DVR, RSDVR, media player, or other source of input data. Stated another way, the concepts described herein could equivalently consider automatic switching between a live broadcast and a pre-recorded program, and/or two pre-recorded programs.

FIG. 1 shows receiver device 102 as having a conventional processor 103, memory 104 and input/output interfaces 105. Processor 103 may be a general purpose processor, controller, digital signal processor or other component that is capable of executing software instructions stored in memory 104 or elsewhere. In many implementations, the scene classification and scene detection functions are carried out by modules 114 and 115 (respectively) implemented as software stored in memory 104 and executed by processor 103. Equivalent embodiments, however, could implement modules 114 and 115 as separate hardware logic, as desired.

In operation, then, receiver device 102 suitably receives one or more program signals 113A-B that can be analyzed, classified and selected for output 125 to implement the viewer's preferences. Additional detail about each of these functions is described below.

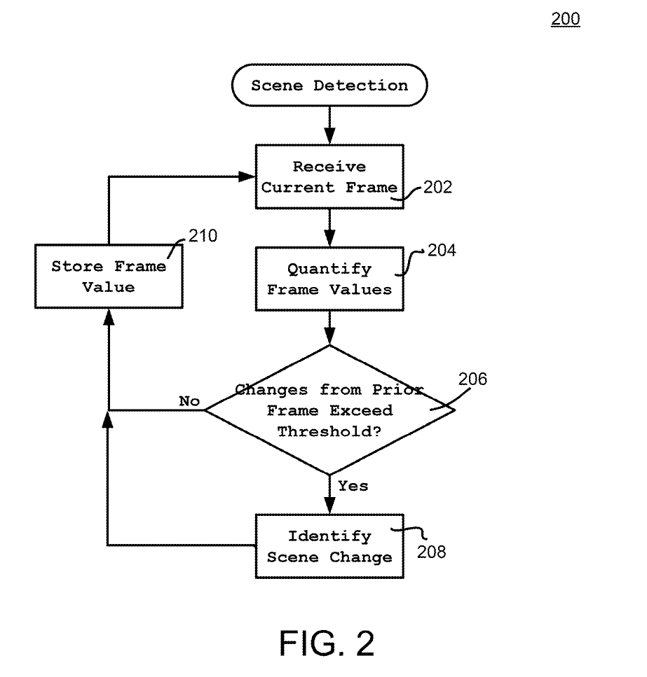

FIG. 2 is a flowchart showing an exemplary process 200 to detect a scene change in video programming. Process 200 could be applied to any frame-based program stream 113, such as any program stream in MPEG format or the like obtained from a television tuner, digital video recorder (DVR), media player interface, network interface and/or other source as desired.

Generally speaking, scene changes can be identified through changes from one video frame to another. In the example of FIG. 2, a current frame of the video stream is received (function 202) and numerically analyzed (function 204) to quantify a numerical value for the frame. The frame value may be based upon an analysis of pixel values (e.g., pixel intensity, pixel color, etc.) or other data values that represent content of the video frame, and may be based upon any algorithm that indicates changes from one frame to another. A digest algorithm could be applied to the various pixel values, for example, or the pixel values within a frame could simply be summed, averaged or otherwise processed to arrive at a numerical result for the frame. Some implementations may analyze only a subset of the pixels in the frame to increase speed or reduce computational demands; the various pixels analyzed may be selected using statistical methods, or in any other manner. Frame values are typically stored (function 210) for use in evaluating future frames of video stream 113.

Generally speaking, sequential frames of a video stream exhibit relatively few changes from each other unless a scene change occurs. When the differences between frames are significant, then, a scene change can be inferred (function 208). In an embodiment that simply sums or averages pixel intensities, for example, a scene change is indicated when the summed or averaged intensities between frames differ by more than a threshold value (function 206). This could indicate a change in background scenery, for example, or another change in scene as desired. The particular threshold value used will vary depending upon the particular implementation, and could be determined from experimentation, trial-and-error or other techniques. In some implementations, the threshold value may be configurable by the viewer depending upon the confidence level desired. That is, at some times it may be desirable to ensure that all scene changes are detected, whereas at other times excess scene changes may be considered to be annoying. In the latter case, the threshold value could be set higher so that smaller differences in frame values did not trigger “false positive” scene changes. Note that it is not necessary in all cases to consider differences in sequential frames; it may be possible in some settings to track changes between frames that are not necessarily sequential in video stream 113. Tracking differences in non-sequential frames may help to accentuate differences between frames and to reduce processing demands associated with tracking differences between large numbers of frames. Frame analysis could be carried out at any desired time interval to prevent unnecessary processing and/or too frequent scene changes while still allowing scene detection resolution at a fine enough time interval that is acceptable to the viewer.

The general concepts shown in FIG. 2 can be supplemented in any manner. Often, for example, commercials in broadcast programming are preceded by several entirely blank frames. These blank frames can be explicitly detected in some situations if the automatic analysis of the frame values does not automatically identify the change in scene. Other special types of frames that are already present within the media stream may be identified and processed as desired.

Still other embodiments could analyze only a portion of the video frame to determine scene changes. Many networks, for example, provide a “bug” or network identifier that is visible on the screen during regular programming that is not present during commercials. By analyzing the portion of the display imagery that would be expected to contain the “bug”, then, the device 102 would be able to recognize times when the bug is not present, thereby indicating commercial scenes.

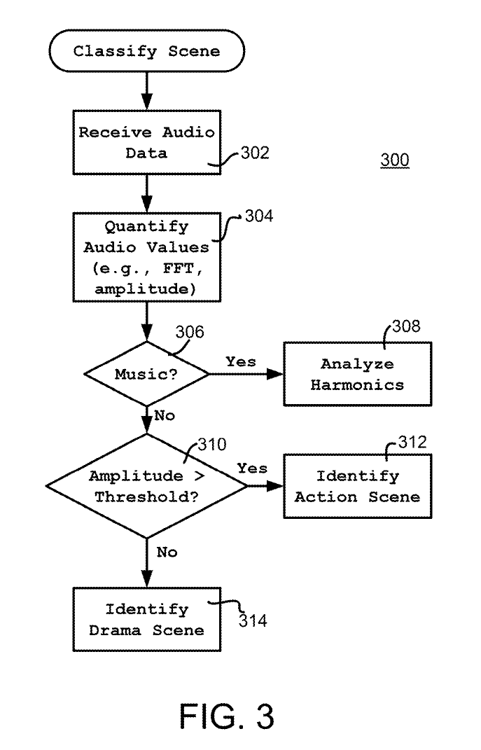

After a scene change is detected, it is typically desirable to classify the new scene so it can be determined whether the scene is of interest to the viewer. FIG. 3 shows an exemplary process 300 that can be executed within a television receiver or other consumer-operated media device 102 to classify the scene based upon its audio content. Typically, the soundtrack to a television program or other media stream contains audio cues that can greatly aid in identifying the type of scene. The intensity of the audio signal generally is far greater during action sequences than during dramatic sequences, for example.

To that end, FIG. 3 shows process 300 as receiving audio data from the media stream 113 (function 302) and quantifying the audio data in an appropriate manner (function 304). In various embodiments, the device 102 performs a fast Fourier transform (FFT) or other analysis to quantify the frequency effects of the audio. Other embodiments could simply look to the amplitude of the audio signal, and/or any other factors as desired. If the audio amplitude exceeds a threshold value, for example (function 310), then the scene can be determined to be an action scene (function 312) or the like. If the audio content does not exceed the audio threshold, then the “quieter” scene may be identified as a “dramatic” scene, as appropriate (function 314). Any number of different scene types could be detected using Fourier analysis, amplitude analysis and any number of threshold values, as desired. In some implementations, for example, musical sequences can be analyzed to determine harmonics and/or other factors (functions 306, 308), thereby allowing scenes to be classified based upon their audio content. In such embodiments

Still other embodiments could classify the scene based upon changes in the video imagery. The scene change analysis described in conjunction with FIG. 2 above, for example, could be augmented to classify the new scene. Action scenes, for example, would typically have more frame-to-frame differences than a drama scene or a dialog scene. Even in an action scene, the differences between frames may be somewhat less than the differences that would indicate a scene change, since sequential frames may still have common background imagery or the like. Nevertheless, the changes representing a speeding car, a person engaged in physical activity, or some other form of action can be measurably different than the changes representing lip movement or other dramatic sequences. These differences can be quantified in any manner (e.g., using experimental data) and compared to appropriate thresholds to classify scenes as well as to identify breaks between different program scenes. Many alternate techniques for identifying or classifying different scenes could be used in equivalent embodiments.

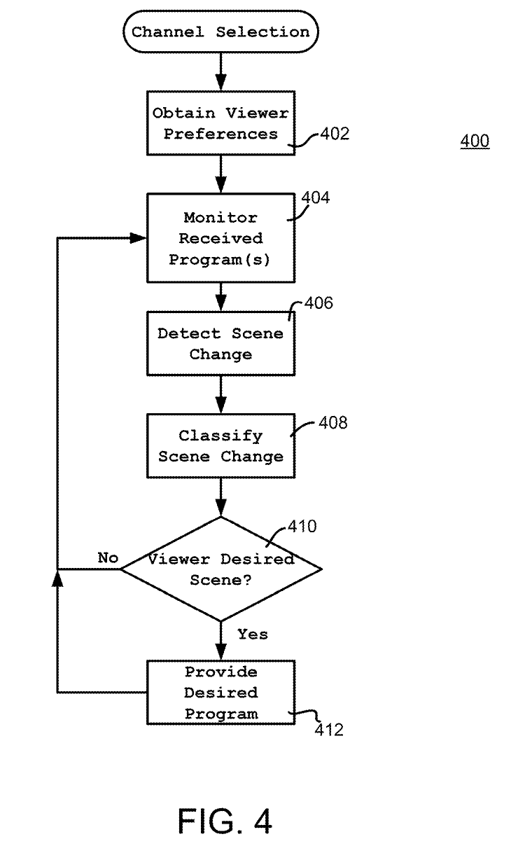

FIG. 4 shows an exemplary process 400 for automatically selecting a channel for viewing based upon viewer inputs and automatically-detected scene changes. With reference to FIG. 4, viewer inputs are received in any appropriate manner (function 402). In various embodiments, the viewer selects primary, secondary and/or other programs for viewing using the remote control or other interface features provided by device 102. Some implementations may allow remote programming of device 102 using a web service or other feature, as desired. Viewers also select the scenes that they want to watch and/or any other relevant features.

The received program streams 113A-B are monitored as appropriate (function 404). As noted above, the streams 113A-B may be received from a television tuner/decoder, a DVR, a media player, a network interface and/or any other source. Note that it may not be necessary to monitor all received streams at all times. Some embodiments could assume, for example, that a particular scene currently viewed by the viewer will be held until the scene is over, regardless of the programming on the other stream. In such embodiments, monitoring the unwatched stream could be suspended temporarily, as desired.

Scene changes may be detected in any manner (function 406). Process 200 above, for example, could be used to detect changes in scenes based upon changes between frames contained in the program stream 113. Alternate embodiments could detect scene changes in any other manner.

Detected scene changes may be classified, as desired (function 408). Process 300, for example, could be used to classify the newly-received scene based upon audio content contained within the stream. In some implementations, the viewer could simply indicate that commercials in either program stream could be skipped, without providing a preference for drama or action scenes. In such embodiments, the device 102 may not attempt to classify the various scenes beyond simply identifying when and where commercials are present in streams 113A-B.

If the newly-received scene is of interest to the viewer as determined by the viewer preferences (function 410), then device 102 automatically provides the scene as an output 125 for presentation to the viewer on display 120 (function 412). This has the effect of automatically switching between television channels or other sources of video programming even though the programming itself may not be specially encoded with metadata or other information.

Generally speaking, the various functions and features of processes 200, 300 and 400 may be automatically executed by any sort of hardware, software and/or firmware logic that is stored and/or executed on any platform. Some or all of method 200 may be carried out, for example, by programmed logic executing within data processing system 100 in FIG. 1. In one embodiment, processor 103 executes software logic that performs each of the various functions associated with processes 200, 300 and 400. Such logic may be stored in memory 104 or in any other non-transitory storage available to processor 103 as desired. The particular logic and hardware that implements any of the various functions shown in FIGS. 2-4 may vary from context to context, implementation to implementation, and embodiment to embodiment in accordance with the various features, scenarios and structures set forth herein. The particular means used to implement each of the various functions shown in FIGS. 2-4, then, could be any sort of hardware processing structures that are capable of executing conventional software logic in any format. Such processing hardware may include processor 101 or other components of system 100, as well as any other processors or other components associated with any conventional DVRs, STBs, media players and/or other devices as appropriate.

The general systems, structures and techniques described above may be inter-combined, enhanced, modified and/or otherwise implemented to provide any number of different features. Although the preceding discussion focuses primarily on satellite, cable and terrestrial broadcast sources of television, for example, equivalent embodiments could apply the same features in any other context, including any sort video file delivery or streaming video format (e.g., streaming video over the Internet or another network), cinema format and/or the like.

The term “exemplary” is used herein to represent one example, instance or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method executable by a media device that provides video programming comprising a first program and a second program for a viewer, the method comprising:
initially providing the first program as an output for presentation to the viewer;
receiving sequential frames of the second program at the media device during presentation of the first program;
identifying changes between a current video frame of the second program and a prior video frame of the second program by the media device;
automatically identifying a different scene of the second program by the media device if the changes between the current frame and the prior video frame exceed a threshold value; and
in response to identifying the different scene of the second program, the media device automatically switching to output the second program for presentation of the different scene to the viewer.

2. The method of claim 1 further comprising the media device automatically classifying the different scene of the second program.

3. The method of claim 2 further comprising initially obtaining viewer preferences for viewing scenes of the second program.

4. The method of claim 3 further comprising simultaneously identifying changes between frames of both the first program and the second program.

5. The method of claim 4 wherein the automatic switching comprises automatically switching between the first program and the second program based upon the viewer preferences.

6. The method of claim 5 wherein the first program is obtained from a digital video recorder and the second program is obtained from a live television broadcast.

7. The method of claim 6 wherein the automatically switching comprises automatically switching to provide the live television broadcast of the second program when the different scene of the television broadcast is of interest to the viewer, and otherwise providing the first program obtained from the digital video recorder.

8. The method of claim 2 wherein the automatic classifying is based upon audio content of the different scene of the second program.

9. The method of claim 2 wherein the automatic classifying comprises analyzing frequency information about the audio content of the second program.

10. The method of claim 2 wherein the automatic classifying comprises analyzing an intensity of the audio content of the second program.

11. A method executable by a television receiver, the method comprising:
receiving broadcast television program data representing a television program at the television receiver, wherein the broadcast television program data comprises a plurality of video frames and audio content associated with the television program;
automatically detecting a change in a scene of the television program by the television receiver based upon changes in the video frames of the television program;
automatically classifying the scene of the television program by the television receiver based upon the audio content associated with the television program;
determining if the classified scene of the television program is of interest to a viewer of the television receiver; and
if the classified scene is of interest to the viewer of the television receiver, automatically providing the classified scene as an output for presentation to the viewer.

12. The method of claim 11 wherein the determining comprises analyzing previously-received user preferences that identify scenes of interest to the viewer.

13. The method of claim 11 wherein the automatically providing comprises automatically switching the output for presentation to the viewer from another program to the classified scene of the television program.

14. The method of claim 11 wherein the other program is obtained from a digital video recorder and the television program is obtained from a live television broadcast.

15. A television receiver comprising:
a receiver interface configured to receive broadcast television signals representing a television program;
a display interface configured to provide the television program as an output for presentation to a viewer;
a television tuner configured to decode the received broadcast television signals into video frames and audio data; and
a processor configured to automatically detect changes in a scene depicted within the television program based upon changes in the video frames, to automatically classify the scene depicted within the television program based upon the audio data, to determine if the classified scene is of interest to the viewer, and, if the classified scene is of interest to the viewer, to control the display interface and thereby provide the classified scene as the output for presentation to the viewer.

16. The television receiver of claim 15 wherein the classified scene is automatically provided as the output for presentation to the viewer without the viewer manually selecting the television program.

17. The television receiver of claim 16 wherein the output for presentation to the viewer is initially based upon another program, and wherein the output is automatically switched from the other program to the television program when the classified scene of interest to the viewer is determined in the television program.

18. The television receiver of claim 17 wherein processor determines that the classified scene is of interest to the viewer based upon previously-received user preferences.

19. The television receiver of claim 16 further comprising a digital video recorder configured to store a stored television program.

20. The television receiver of claim 19 wherein the processor is configured to initially provide the stored television program from the digital video recorder as the output to the viewer until classified scene of interest is determined in the received television program, and wherein the processor automatically switches the output from the stored television program to the received television program when the classified scene of interest is determined.
